(19) United States
(12) Patent Application Publication
(10) Pub. No.: US 2011/0179248 A1
(43) Pub. Date: Jul. 21, 2011

(54) ADAPTIVE BANDWIDTH ALLOCATION FOR MEMORY

(75) Inventor: Junghae Lee, Palo Alto, CA (US)

(73) Assignee: ZORAN CORPORATION, Sunnyvale, CA (US)

(21) Appl. No.: 12/819,051

(22) Filed: Jun. 18, 2010

Related U.S. Application Data
(60) Provisional application No. 61/295,977, filed on Jan. 18, 2010.
(60) Provisional application No. 61/296,559, filed on Jan. 20, 2010.

(51) Int. Cl. G06F 12/02; G06F 13/368

(52) U.S. Cl. 711/171; 710/242; 711/E12.002

(57) ABSTRACT

A device and methods are provided for adaptive bandwidth allocation for memory of a device are disclosed and claimed. In one embodiment, a method includes receiving, by a memory interface of the device, a memory access request from a first client of the memory interface, and detecting available bandwidth associated with a second client of the memory interface based on the received memory access request. The method may further include loading a counter, by the memory interface, for fulfilling the access request, wherein the counter is loaded to include bandwidth associated with the first client and the available bandwidth associated with the second client, and granting the memory access request for the first client based on bandwidth allocated for the counter.

### CROSS-REFERENCE TO RELATED APPLICATION

This application claims the benefit of U.S. Provisional Application No. 61/295,977, filed Jan. 18, 2010 and U.S. Provisional Application No. 61/296,559, filed Jan. 20, 2010.

### FIELD OF THE INVENTION

The present invention relates in general to memory access and in particular to allocating bandwidth of memory resources.

### BACKGROUND

Many devices employ memory for operation, such as memory systems-on-chip (MSOC). In order to satisfy one or more requests for memory, conventional devices and methods typically control access to a memory unit. For example, one conventional algorithm for controlling memory access is the least recently used (LRU) caching algorithm. In particular, the LRU algorithm and typical conventional methods allow access to memory by limiting the number of access request for each client and the limiting each client to a fixed request period. As a result, the LRU algorithm and other conventional methods underutilize memory bandwidth. Underutilization of memory bandwidth may be particularly significant when a plurality of memory allocations are underutilized. Further, setting fixed request periods does not efficiently allow for access to memory for on-demand requests.

FIG. 1 depicts a graphical representation of a prior art method for accessing memory. In particular, method 100 is shown for two clients, Client 0, shown as 105, and Client 1, shown as 110, of a memory. Conventional methods may employ a deadline counter for each client, shown as Client 0 Counter 115 and Client 1 Counter 120. Based on client requests, and the client counter periods, the memory may be accessed to allow for memory transactions 125 for client 105 and client 110.

As further shown in FIG. 1, conventional methods typically set windows for each client to a particular timer period, shown as 130 and 140 for client 105 and client 110, respectively. The conventional methods additionally limit clients to one request per window which can lead to underutilization of memory, particularly when access periods are not utilized. Further, this approach does not allow for efficient bandwidth allocation for on-demand clients. As a result, underutilization may result in slower processing speed. Requests of client devices 105 and 110, shown as 135 and 145 respectively, may be not be addressed when received and/or bandwidth allocated to a particular client will not be utilized as shown by 150 when memory transactions are idle.

Access method 100, like other conventional methods, thus results in underutilization of memory bandwidth. Further, these methods do not allow for efficient throttling of data. Accordingly, there is a need in the art for adaptive bandwidth allocation for memory.

### BRIEF SUMMARY OF THE INVENTION

Disclosed and claimed herein are a device and methods for adaptive bandwidth allocation for memory of a device. In one embodiment, a method includes receiving, by a memory interface of the device, a memory access request from a first client of the memory interface, detecting available bandwidth associated with a second client of the memory interface based on the received access request, and loading a counter, by the memory interface, for fulfilling the memory access request, wherein the counter is loaded to include bandwidth associated with the first client and the available bandwidth associated with the second client. The method further includes granting the memory access request for the first client based on bandwidth allocated for the counter.

Other aspects, features, and techniques of the invention will be apparent to one skilled in the relevant art in view of the following detailed description of the invention.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 depicts a graphical representation of conventional memory access method;

FIG. 2 depicts a graphical representation of adaptive bandwidth allocation according to one or more embodiments of the invention;

FIG. 3 depicts a simplified block diagram of a device according to one or more embodiments of the invention;

FIG. 4 depicts a process for adaptive bandwidth allocation according to according to another embodiment of the invention;

FIG. 5 depicts a simplified block diagram of a memory interface according to one embodiment of the invention;

FIG. 6 depicts a state diagram deadline counter throttling according to one embodiment of the invention;

FIG. 7 depicts a simplified block diagram of a deadline counter selection device according to one embodiment of the invention; and

FIG. 8 depicts a process for selecting an available bandwidth according to one embodiment of the invention.

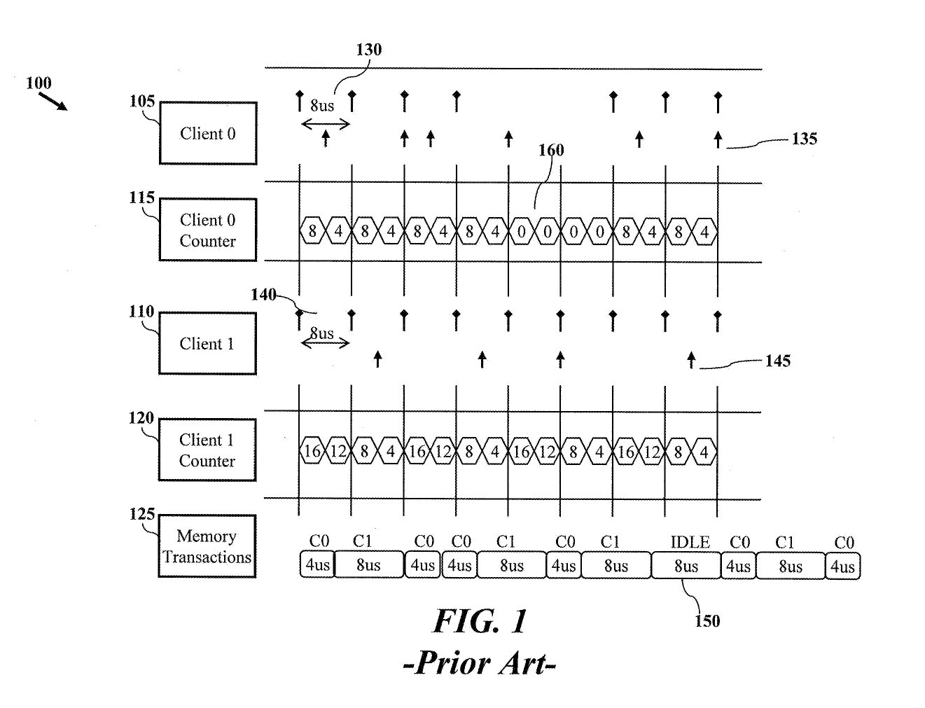

### DETAILED DESCRIPTION OF EXEMPLARY EMBODIMENTS

### Overview and Terminology

One aspect of the present invention relates to adaptive bandwidth allocation of memory. In one embodiment, a process is provided for bandwidth allocation by a memory interface to maximize utilization of memory bandwidth and reduce overhead. The process may include detection of available bandwidth associated with one or more clients of a memory interface, and loading one or more deadline counters to include available bandwidth. This technique may allow for greater flexibility in fulfilling memory access requests and reduce the overhead required to service on-demand and ill-behaved clients.

In one embodiment, a device is provided to include a memory interface for adaptive bandwidth allocation. The device may further include an arbiter or memory interface to select one or more read and write requests for memory of the device. In that fashion, adaptive bandwidth allocation may be provided for display devices, such as a digital television (DTV), personal communication devices, digital cameras, portable media players, etc.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means any of the following: A; B; C; A and B; A and C; B and C; A, B and C. An exception to this definition will occur only when a combination of elements, functions, steps or acts are in some way inherently mutually exclusive.

Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner on one or more embodiments without limitation.

In accordance with the practices of persons skilled in the art of computer programming, the invention is described below with reference to operations that can be performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits

When implemented in software, the elements of the invention are essentially the code segments to perform the necessary tasks. The code segments can be stored in a “processor storage medium,” which includes any medium that can store information. Examples of the processor storage medium include an electronic circuit, a semiconductor memory device, a ROM, a flash memory or other non-volatile memory, a floppy diskette, a CD-ROM, an optical disk, a hard disk, etc.

### Exemplary Embodiments

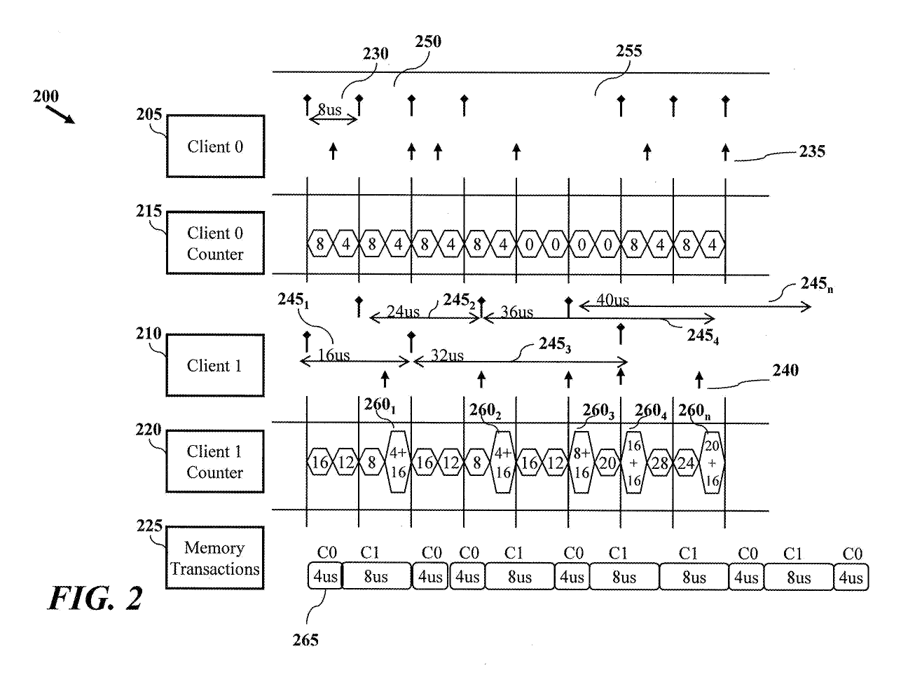

Referring now to the figures, FIG. 2 depicts a graphical representation of adaptive bandwidth allocation according to one or more embodiments of the invention. Adaptive bandwidth allocation as depicted in FIG. 2 may be provided for one or more clients of a memory of a device. In one embodiment, adaptive bandwidth allocation method 200 may re-allocate bandwidth to other clients requiring additional data. In FIG. 2, adaptive bandwidth allocation is depicted for two clients, client 205 and client 210. According to one embodiment, a memory interface may employ a counter, such as a deadline counter for throttling requests of clients. As depicted in FIG. 2, client 0 counter 215 and client 1 counter 220 are depicted for client 205 and client 210, respectively. Memory transactions for clients 205 and 210 are shown as 225.

According to one embodiment, adaptive bandwidth allocation as described herein may be provided for different types of memory clients. For example, memory allocation may be adjusted based on the type of memory clients, such as well-behaved clients, ill-behaved clients, and on-demand clients. Well behaved clients may relate to clients that typically issue requests at an average data rate. Ill-behaved clients may relate to clients that issue requests faster than the average data rate and thus, have a peak data rate substantially higher that the average data rate. On-demand clients relate to clients which do not require memory bandwidth constantly, but rather on a demand basis. From a memory arbitration perspective, well-behaved clients are ideal. However, many devices, such as DTV systems for example, involve providing access requests for ill-behaved clients and on-demand clients. Accordingly, memory allocation as described herein may allow for soft throttling to service well-behaved, ill-behaved, and/or on-demand clients.

According to one embodiment, adaptive bandwidth allocation may include setting the bandwidth for one or more clients. Further, adaptive bandwidth allocation may include re-allocation of unclaimed bandwidth to other clients via soft throttling. By re-allocating bandwidth, memory overhead may be minimized while maximizing bandwidth utilization. According to another embodiment, memory access may be based on the type of access stream and/or client.

As depicted in FIG. 2, client 205 is allocated time periods of 8 μs, shown by 230, for a deadline counter period. Deadline counter period 230 may be based on weighted fair queuing (WFQ) to calculate finishing time of data transactions assuming bit by bit weighted round robin selection among clients. Requests by client device 205 are shown by 235, while requests by client 220 are shown by 240. Deadline counter periods for client 220 are shown by 245₁₋ₙ. In one embodiment, deadline counter period for client 220 may be set to an initial deadline period of 16 qs shown by 245₁. Initial deadline counter periods may be based on worst case scenario for a memory interface to service all clients. However, according to one embodiment of the invention, deadline counter periods for client 220 may be adaptively allocated based on unclaimed memory of one or more other clients. For example, as depicted in FIG. 2, time interval 250 relates to an unclaimed time interval by client 205, while time interval 255 related to an idle period by client 205. Based on idle or unclaimed memory periods, bandwidth allocated to a client, may be utilized by another client. In one embodiment, deadline counter periods associated with unclaimed bandwidth may be added to a deadline counter period of another client, shown by deadline counter periods 260₁₋ₙ and in particular dead line counter period 245₂₋ₙ of FIG. 2. In that fashion, unclaimed bandwidth, such as time intervals 250 and 255 may be utilized.

As shown by memory transactions 225, requests of client 205 and 210 are shown as handled by a memory arbiter, shown as 265. Further, memory transactions illustrate that request of client 210 may be handled such that memory bandwidth of another client device is utilized as shown by 270. For example, as indicated by 270, memory access requests of client 220, the second client, may be handled using memory bandwidth of the client 205.

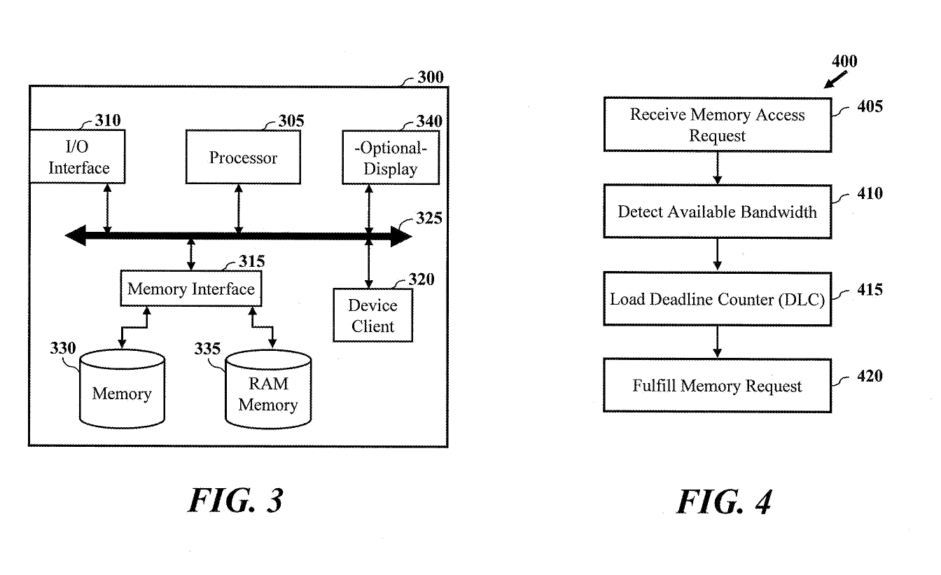

Referring now to FIG. 3, a simplified block diagram is depicted of a device according to one embodiment. In one embodiment, device 300 may be configured to provide access to memory using the adaptive bandwidth allocation process as described herein. As depicted in FIG. 3, device 300 includes processor 305 coupled to input/output (I/O) interface 310, and memory interface 315. Processor 305 may be configured to interoperate with one or more elements of device 300, such as memory interface 315 via bus 325. Processor 305 may be configured to process one or more instructions stored on memory of the device, shown as memory 330 and RAM memory 335, and/or data received via I/O interface 310.

In one embodiment, adaptive bandwidth allocation may be employed to service one or more clients of memory of the device 300. In one embodiment, access of memory of device 300 may provided by memory interface 315 for one or more clients, such as processor 305, device client 320 and optional display 340. Device client may relate to one or more components, for example, audio or video decoders, for operation of the device. Based on the type of requests made by client device 320, memory interface 315 may be configured to allocate bandwidth for fulfillment of one or more requests.

Memory 330 may relate to one a memory storage device, such as a hard drive. Memory 335 may relate to random access memory (RAM), read only memory (ROM), flash memory, or any other type of volatile and/or nonvolatile memory. In certain embodiments, memory 335 may include Synchronous Dynamic Random Access Memory (SDRAM), Static RAM (SRAM), Dynamic RAM (DRAM), Double Data Rate RAM (DDR), etc. It should further be appreciated that memory of device 300 may be implemented as multiple or discrete memories for storing processed data, as well as the processor-executable instructions for processor 305. Further, memory of device 300 may include to removable memory, such as flash memory, for storage of image data.

Device 300 may be configured to employ adaptive bandwidth allocation for to execute one or more functions of the device, including display commands, processing graphics. In certain embodiments, device 300 may relate to a display device and/or device including a display, such as a digital television (DTV), personal communication device, digital camera, portable media player, etc. Accordingly, in certain embodiments device 300 may include optional display 340. Optional display 320 may relate to or more of a liquid crystal display (LCD), light-emitting diode (LED) display and display devices in general. Adaptive bandwidth allocation of memory may be associated with one or more display commands by processor 305. In other embodiments, adaptive memory allocation may be employed for functions of a personal media player and/or camera.

Although FIG. 3 has been described above with respect to a display devices, it should be appreciated that device 300 may relate to other devices which including access to memory.

Referring now to FIG. 4, a process is depicted for adaptive bandwidth allocation according to one or more embodiments of the invention. In one embodiment, process 400 may be performed by a memory interface of device, such as the device of FIG. 3. Process 400 may be initiated by receiving memory access requests associated with one or more memory clients at block 405. Memory access requests may relate to read requests and write requests of the device memory. In one embodiment, the first client may relate to an on-demand client, wherein additional bandwidth is required to fulfill the on-demand request. According to another embodiment, bandwidth allocations may be based on the type of clients of the device, such as well-behaved clients, ill-behaved clients and on-demand clients.

At block 410, the memory interface may detect available bandwidth associated with a second client of the memory interface based on the received access request. In one embodiment, available bandwidth may relate to one of unused and unclaimed bandwidth allocated for the second client of the memory interface. Initial bandwidth may be allocated to clients of the memory interface based on an estimated client request period. Further, deadline counter periods may be loaded for each client based on the bandwidth assigned to the client. Available bandwidth may be detected based on a selection of a deadline counter that reaches zero first, as will be discussed in more detail below with respect to FIG. 7.

At block 415, the memory interface may load a deadline counter of the client to fulfilling the access request. The deadline counter may be loaded to include bandwidth associated with the first client and the available bandwidth associated with the second client. In that fashion, unused bandwidth may be loaded to allow for soft throttling of a client deadline counter for fulfilling the request. Soft throttling may similarly allow for reloading a deadline counter of the first client based on an approximation of requests received for the first client. For example, inactivity of a client may prompt the memory interface to fulfill plurality of client requests during a single deadline period.

Process 400 may then fulfill the memory access request for the first client based on bandwidth allocated to the deadline counter at block 420. In that fashion, adaptive bandwidth allocation may be provided for an access request of a memory interface. Adaptive bandwidth allocation as provided in process 400 may be employed for one or more of a memory system-on-chip and a digital television (DTV) memory allocation system. Further, a plurality of requests from the first client during a deadline counter period by approximating error of the second client.

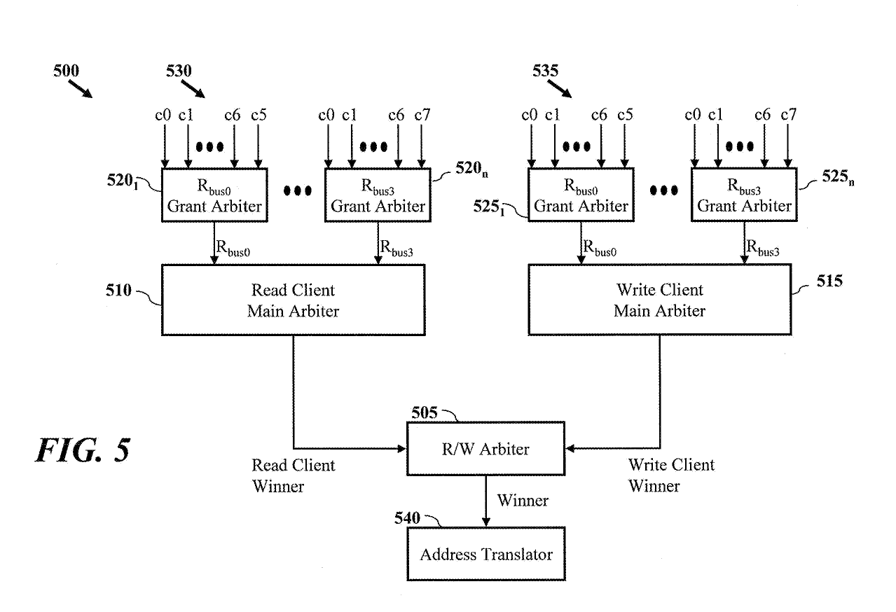

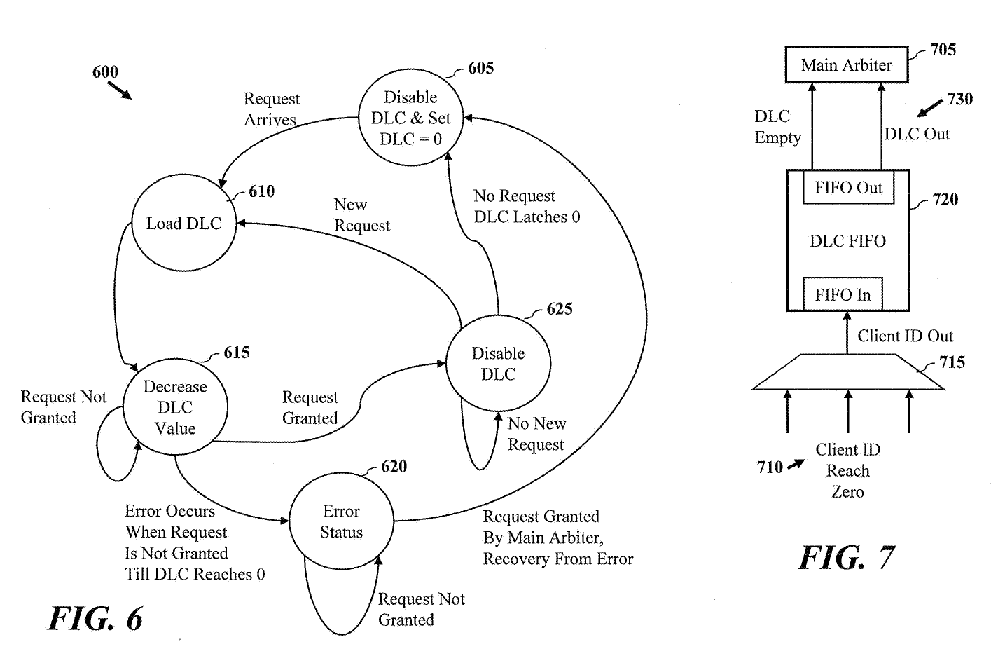

Referring now to FIG. 5, a simplified block diagram is depicted of a memory interface according to one embodiment of the invention. Memory interface 500 (e.g., memory interface 315) may be configured for arbitration of one or more memory requests by clients of a device (e.g., device 300). Memory interface 505 includes read/write (R/W) arbiter 505 configured to adaptively allocate memory access. In one embodiment, R/W arbiter 505 may be configured to employ the process of FIG. 4, to adaptively allocate bandwidth. According to another embodiment, R/W arbiter 505 may be configured to adjust one or more deadline counters of memory clients as will be discussed in more detail with respect to FIG. 6.

R/W arbiter 505 may be configured to receive one or more of access requests, such as read and write requests, from clients of device memory (e.g., memory 330 and memory 335). According to one embodiment, memory interface 500 includes read client main arbiter 510 configured to detect one or more read requests. According to another embodiment, memory interface 500 may be coupled to a bus to receive one or more memory access requests. Similarly, memory interface 500 may include write client main arbiter 515 configured to detect one or more write requests. Accordingly, memory interface 500 may include a plurality of grant arbiters, for servicing one or more clients. Bus grant arbiters 570₁₋ₙ may be configured to service one or more clients, shown as 530, for read requests. Similarly, bus grant arbiters 570₁₋ₙ may be configured to service one or more clients, shown as 535, for write requests. R/W arbiter 535 may be configured to allow for adaptive allocation to one or more of clients 530 and 535 by providing adaptive bandwidth allocation. Memory interface 500 may further include address translator 540 configured to translate one or access requests provided by arbiter 505 to a memory.

Referring now to FIG. 6, a graphical representation is depicted of deadline counter operation according to one or more embodiments. According to one embodiment, a deadline counter may be set for each client buy a memory interface (e.g., memory interface 500). According to another embodiment, the deadline counter may be set based on a throttle setting in a control filed of the memory interface. For example, the deadline counter may be set based on no throttling (throttle=0), for hard throttling (throttle=1) and soft throttling (throttle=2). No throttling allows for the deadline counter of each client to be reloaded when a current request has been serviced, and the next request is available in queue. Hard throttling relates to reloading the deadline counter when the deadline counter reaches zero and the next request is available in the queue. Soft throttling, as discussed herein related to reloading a deadline counter when the current request has been serviced and the next request is in queue, wherein the new value of the deadline counter may include previously unused memory bandwidth. For example, soft throttling may allow for unused portions of the deadline counter to be added to a subsequent deadline counter period of another client, or other request. In that fashion, memory bandwidth may be adaptively allocated and overhead may be minimized. Accordingly, the state machine depicted in FIG. 6 may be employed to set a deadline counter according to one or more embodiments.

Initially, a deadline counter may be disabled and set to zero, as depicted at block 605. When a request arrives, the deadline counter (DLC) may then be loaded with an initial value at block 610. The initial value for the deadline counter may be based on the particular client. The deadline counter may then be decreased, at block 615, when the request has not bee serviced. When the request has not been granted, the arbiter may then determine an error status when the deadline counter expires (e.g., reaches 0) at block 620. Error status may prompt the arbiter to schedule the request again by resetting the deadline counter at block 605. Returning to the deadline counter decreasing at block 615, when the request is granted (e.g., access to the memory for read or write access is completed), the deadline counter may then disable the deadline counter at block 625. Disabling the deadline counter for the particular client may allow for the period of time allocated to the client to be provided to another client, and/or other request. Thus, at block 610, soft throttling may allow for the period of time remaining on the deadline counter to be added to the initial value of time associated with the client at block 610.

According to one embodiment, the deadline counter bit-width may be set to support the longest period of all clients instantiated. Further, deadline counter bits may additionally accommodate implementation of soft throttling as described herein. For example, the deadline counter may be defined as a 12-bit counter which increases every 4 cycles of a system clock. According to another embodiment, the deadline counter for each client may be associated with other values. Further, the deadline counter may be associated with other bit lengths. For example, in certain embodiments the deadline value of each client must be at least ten bits because the least significant 2 bits do not have to be specified.

Referring now to FIG. 7, a simplified block diagram is depicted of circuit diagram for selection of one or more client requests for soft throttling by an arbiter. In one embodiment, a deadline counter first-in-first-out selector (DLC FIFO) may be employed. As shown in FIG. 7, one or more clients may be selected by main arbiter 705 (e.g., arbiter 500) for selection to allow for soft throttling of the client. For example, clients with deadline counters that reach zero the earliest while waiting to be served may be logged. One or more clients, shown as 710, with deadline counters that expire may be selected by multiplexer 715. The deadline counter which reaches zero first may be detect by DLC FIFO 720 for output to main arbiter 705 via output 725. In one embodiment, client identification (e.g., bus number and port number) may be stored in DLC FIFO 720. When none of the deadline counters reach zero, the DLC FIFO 705 may notify main arbiter 705 via output 730.

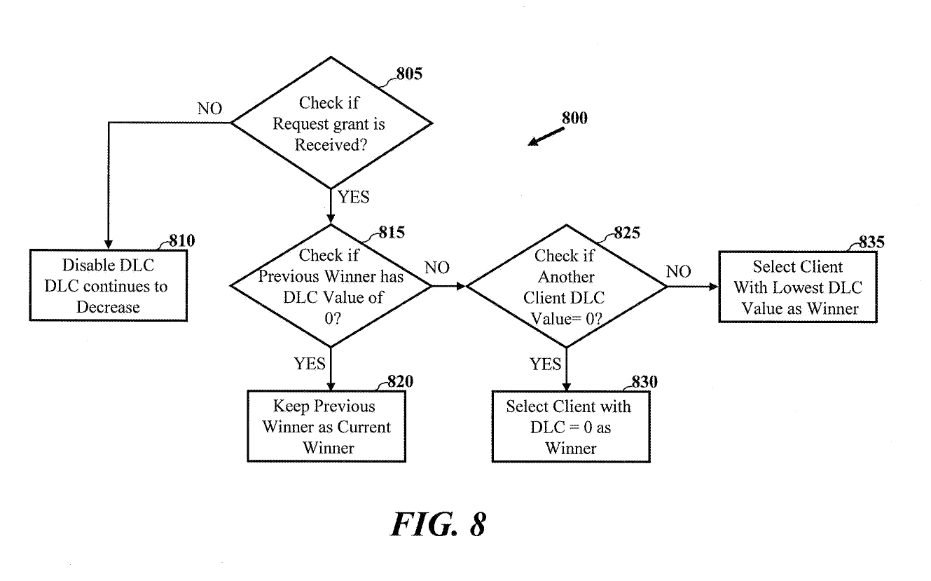

Referring now to FIG. 8, a process is depicted for selecting bandwidth for soft throttling according to one embodiment. In one embodiment, process 800 may be performed by a memory interface (e.g., memory interface 300) to select bandwidth associated with a client when a request grant is received by a client arbiter (e.g., read arbiter 510 and write client main arbiter 515). Process 800 may be initiated by checking if a request grant is received at decision block 805. When a request grant is not received (“NO” path out of decision block 805), the deadline counter is disabled and set to zero. When a request grant is received (“YES” path out of decision block 805), the arbiter may check if the previous winner has a deadline counter value of zero at decision block 815. Checking the previous winner may allow for the bandwidth associated with the previous winner to be used for servicing the client if necessary.

When the previous winner has a DLC value of zero (“YES path out of decision block 815), the arbiter may then keep the previous winner as the current winner at block 820. The winner may then be used for fulfilling the grant request. When the previously selected winner does not have a DLC value of zero (“NO” path out of decision block 815), the arbiter may then check if any client has a deadline counter value of zero at decision block 825. Clients with deadline counter values of zero may be provided by a DLC FIFO of the memory interface. When a client is provided with the deadline counter of zero (“YES” path out of decision block 825), the arbiter selects the client for fulfilling the request at block 830. When all clients are busy (“YES” path out of decision block 825), the arbiter selects the client with the lowest deadline counter value at block 835 as the winner.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. Trademarks and copyrights referred to herein are the property of their respective owners.

What is claimed is:

1. A method for adaptive bandwidth allocation for memory of a device, the method comprising the acts of:
receiving, by a memory interface of the device, a memory access request from a first client of the memory interface;
detecting available bandwidth associated with a second client of the memory interface based on the received access request;
loading a counter, by the memory interface, for fulfilling the memory access request, wherein the counter is loaded to include bandwidth associated with the first client and the available bandwidth associated with the second client; and
granting the memory access request for the first client based on bandwidth allocated for the counter.

2. The method of claim 1, wherein the memory access request relates to one of a read request, and a write request of the device memory.

3. The method of claim 1, wherein available bandwidth relates to one of unused and unclaimed bandwidth allocated for the second client of the memory interface.

4. The method of claim 1, wherein detecting available bandwidth is based on a selection of a counter that reaches zero first, and assigning bandwidth for a client associated with said counter for fulfilling the memory access request.

5. The method of claim 1, wherein loading the counter relates to soft throttling to reload a counter of the first client with unused bandwidth allocated to the second client.

6. The method of claim 1, wherein loading the counter relates to soft throttling to reload a counter of the first client based on an approximation of requests received for the first client.

7. The method of claim 1, wherein bandwidth is allocated to clients of the memory interface based on an estimated client request period.

8. The method of claim 1, further comprising assigning bandwidth to one or more clients of the memory interface, wherein a counter period is loaded for each client based on the bandwidth assigned to the client.

9. The method of claim 1, wherein the first client relates to an on-demand client, and wherein the request is granted for the on-demand client by the memory interface based the available bandwidth allocated to a scheduled client.

10. The method of claim 1, wherein adaptive bandwidth allocation is provided for one or more of a memory system-on-chip and a digital television (DTV) memory allocation system.

11. The method of claim 1, further comprising granting a plurality of requests from the first client during a counter period by approximating error of the second client.

12. A device configured adaptive bandwidth allocation for memory, the device comprising:
a memory
a processor; and
a memory interface coupled to the memory and the processor, the memory interface configured to
receive a memory access request from a first client;
detect available bandwidth associated with a second client based on the received access request;
load a counter for fulfilling the memory access request, wherein the counter is loaded to include bandwidth associated with the first client and the available bandwidth associated with the second client; and
grant the memory access request for the first client based on bandwidth allocated for the counter.

13. The device of claim 12, wherein the memory access request relates to one of a read request, and a write request of the device memory.

14. The device of claim 12, wherein available bandwidth relates to one of unused and unclaimed bandwidth allocated for the second client of the memory interface.

15. The device of claim 12, wherein detecting available bandwidth is based on a selection of a counter that reaches zero first, and assigning bandwidth for a client associated with said counter for fulfilling the memory access request.

16. The device of claim 12, wherein loading the counter relates to soft throttling to reload a counter of the first client with unused bandwidth allocated to the second client.

17. The device of claim 12, wherein loading the counter relates to soft throttling to reload a counter of the first client based on an approximation of requests received for the first client.

18. The device of claim 12, wherein bandwidth is allocated to clients of the memory interface based on an estimated client request period.

19. The device of claim 12, further comprising assigning bandwidth to one or more clients of the memory interface, wherein a counter period is loaded for each client based on the bandwidth assigned to the client.

20. The device of claim 12, wherein the first client relates to an on-demand client, and wherein the request is granted for the on-demand client by the memory interface based the available bandwidth allocated to a scheduled client.

21. The device of claim 12, wherein adaptive bandwidth allocation is provided for one or more of a memory system-on-chip and a digital television (DTV) memory allocation system.

22. The device of claim 12, further comprising granting a plurality of requests from the first client during a counter period by approximating error of the second client.
